(19) United States
(12) Patent Application Publication
(10) Pub. No.: US 2026/0133372 A1
(43) Pub. Date: May 14, 2026

(54) DEMOUNTABLE HIGH DENSITY OPTICAL CONNECTOR

(71) Applicant: Senko Advanced Components, Inc., Hudson, MA (US)

(72) Inventors: Yang CHEN, Thousand Oaks, CA (US); Robert Ryan VALLANCE, Newbury Park, CA (US); King-Fu HII, Newbury Park, CA (US); Kazuyoshi TAKANO, Tokyo (JP)

(21) Appl. No.: 19/390,226

(22) Filed: Nov. 14, 2025

Related U.S. Application Data
(60) Provisional application No. 63/720,550, filed on Nov. 14, 2024.
(60) Provisional application No. 63/729,896, filed on Dec. 9, 2024.
(60) Provisional application No. 63/738,909, filed on Dec. 26, 2024.
(60) Provisional application No. 63/775,033, filed on Mar. 20, 2025.
(60) Provisional application No. 63/829,415, filed on Jun. 24, 2025.

(51) Int. Cl. G02B 6/38

(52) U.S. Cl. CPC G02B 6/3853; G02B 6/3873

(57) ABSTRACT

A high-density optical connector for demountable coupling to an external component having a fiber block that includes a body supporting a 2-D array of optical fibers, a 2-D array of microlenses aligned with the optical fibers for beam shaping, a coupling surface having passive alignment demountable coupling features matching complementary coupling features on a receptacle associated with the external connection point to be coupled, wherein the coupling surface comprises an optical region aligned with the microlens array and the optical fiber array permitting passage of light to and from optical fibers, with the demountable coupling features distributed adjacent the optical region in reference to the microlens array and optical fiber, and wherein the demountable coupling features are symmetrically arranged about at least one of two orthogonal axes of optical region.

### 1. PRIORITY CLAIM

This application claims the priorities of: (a) U.S. Provisional Ser. No. 63/720,550 filed on Nov. 14, 2024; (b) U.S. Provisional Ser. No. 63/729,896 filed on Dec. 9, 2024; (c) U.S. Provisional Ser. No. 63/738,909 filed on Dec. 26, 2024; (d) U.S. Provisional Ser. No. 63/775,033 filed on Mar. 20, 2025; and (e) U.S. Provisional Ser. No. 63/829,415 filed on Jun. 24, 2025; These applications are fully incorporated by reference as if fully set forth herein. All publications noted below are fully incorporated by reference as if fully set forth herein.

### BACKGROUND OF THE INVENTION

### 2. Field of the Invention

The present invention relates to coupling of light into and out of optoelectronic components (e.g., photonic integrated circuits (PICs), laser arrays, photodiode arrays, etc.), and in particular demountable high-density optical connectors for coupling to optoelectronic components.

### 3. Description Of Related Art

Photonic integrated circuits (PICs) or integrated optical circuits are part of an emerging technology that uses light as a means of communication, computing, or sensing as opposed to an electric current. A PIC integrates multiple (at least two) photonic functions and as such is analogous to an electronic integrated circuit. The major difference between the two is that a photonic integrated circuit provides functionality for information signals on optical wavelengths typically in the visible spectrum or near infrared 850 nm-1650 nm.

PICs are used for various applications in telecommunications, instrumentation, sensing, and signal-processing fields. A PIC typically uses optical waveguides to route optical signals throughout the PIC and/or to interconnect various elements, such as optical switches, couplers, routers, splitters, multiplexers/demultiplexers, modulators, amplifiers, wavelength converters, optical-to-electrical (O/E) (e.g. photodiodes) and electrical-to-optical (E/O) converters (e.g. lasers), etc. An advantage of using light as a basis of circuit operation in a PIC is that its energy cost for high-speed signal transmission is substantially less than that of electronic chips, thus efficient signal transmission between PIC devices and other optical devices, such as optical fibers, that maintains this advantage is an important aspect of PICs.

For proper operation, a PIC needs to efficiently couple light signals between an external optical fiber and one or more on-chip waveguides. Most PICs require single-mode optical connections that require stringent alignment tolerances between optical fibers and the PIC, typically less than 1 micrometer. It is challenging to achieve efficient optical coupling to and from the on-chip waveguides to an external optical fiber in order to achieve an acceptable insertion loss (e.g., <10 dB). The challenge is exacerbated when attempting to achieve acceptable insertion loss across all optical fibers in a high-density optical coupling between a fiber array and a large number of I/O ports on a PIC. The number of I/O ports in a PIC has significantly increased as PIC evolved to handle increasingly higher bandwidth processing for increasingly more complex applications.

Furthermore, given it is impractical to permanently attach an array of optical fibers to PICs, demountable optical connectors have been developed for repeated cycles of connect-and-disconnect-and-reconnect of the optical connectors to the PICs. However, this poses a further challenge to achieve acceptable optical alignment efficiencies through the cycles.

The common assignee of the present application, Senko Advanced Components, Inc., developed proprietary demountable optical connectors that improve optical and mechanical compatibility of optical connectors to PIC devices.

US Patent Publication No. 2016/0161686A1 (commonly assigned to the assignee of the present application and fully incorporated by reference herein) discloses passive alignment based demountable optical connectors for optoelectronic devices. Further, U.S. Pat. No. 11,500,166 (commonly assigned to the assignee of the present application and fully incorporated by reference herein) further discloses specific embodiments of passive optical alignment couplings based on elastic averaging. As its principles are known in the prior art, elastic averaging represents a subset of surface coupling types where improved accuracy is derived from the averaging of errors over a large number of contacting surfaces. Contrary to kinematic design, elastic averaging is based on significantly over-constraining the solid bodies with a large number of relatively compliant members. As the system is preloaded, the elastic properties of the material allow for the size and position error of each individual contact feature to be averaged out over the sum of contact features throughout the solid body. Although the repeatability obtained through elastic averaging may not be as high as in deterministic kinematically coupled systems, elastic averaging design allows for higher stiffness and lower local stress when compared to kinematic couplings. More importantly, elastic averaging provides for accurate coupling with lower manufacturing tolerances on the contacting surfaces. In a well-designed and preloaded elastic averaging coupling, the accuracy is approximately inversely proportional to the square root of the number of contact points.

US Patent Publication No. 2024/0027703A1 (commonly assigned to the assignee of the present application and fully incorporated by reference herein) discloses a demountable connection of an optical connector to an optoelectronic device using a foundation in the form of a receptacle having features for integrated optical coupling and demountable coupling. The foundation provides for demountable passive alignment connection to an optical connector. The foundation is permanently attached and aligned to a PIC chip. The foundation also includes passive alignment features that match the passive alignment features on the facing side of the optical connector. US Patent Publication No. 2024/0085633A1 (commonly assigned to the assignee of the present application and fully incorporated by reference herein) further discloses a configurable optical multi-connector module implementing demountable coupling based on elastic averaging.

US Patent Publication No. 2024/0142722A1 (commonly assigned to the assignee of the present application and fully incorporated by reference herein) discloses further embodiments of elastic averaging alignment features that are well suited for passive optical alignment coupling between optical connectors and optoelectronic devices. US2025/0284077A1(commonly assigned to the assignee of the present application and fully incorporated by reference herein) further discloses a methodology of using an alignment optical connector to initially align and position a receptacle with respect to an optoelectronic device (which may be at a wafer level) under a close to demountable coupling operational condition, to improve optical alignment for subsequent demountable coupling a data optical connector to the receptacle during active operations.

What is needed is an improved demountable optical connector for high-density optical coupling to optoelectronic devices, which would result in improved tolerance, manufacturability, ease of use, functionality and reliability at reduced costs for high-density optical connections to optoelectronic devices.

### SUMMARY OF THE INVENTION

The present invention overcomes the drawbacks of the prior art by providing an

improved demountable/separable and reconnectable passive alignment coupling/connection that achieves high alignment accuracy and repeatability for high-density optical coupling applications involving an optical fiber array and an external connection point associated with an external component, e.g., an optoelectronic device, e.g., a photonic integrated circuit (PIC) device. In connection with demountable optical coupling, an optical connector supporting an optical fiber array is configured and structured to be non-destructively, removably attachable for reconnection to a foundation in the form of a receptacle located at the external connection point in alignment therewith. The receptable may be an integral part of the external component (e.g., part of a PIC), a separate component attached to the external component, or attached to an access point (e.g., an edge coupler) positioned in reference to the external component (e.g., on a printed circuit board (PCB)), to allow the optical connector to demountably connected thereto to communicate optical signals with the I/O ports of the optoelectronic device. Alternatively, the receptacle may be an integral part of or attached to another optical connector as the “external component”.

The present invention will be explained in connection with the illustrated embodiments using PICs as an example, and not limitation, of optoelectronic devices and within the meaning of an “external component”. The receptacle can be aligned to electro-optical elements (e.g., grating couplers, spot-converters, edge-emitting waveguides, etc.) in the optoelectronic device. The receptacle is permanently positioned with respect to the optoelectronic device to provide an alignment reference to the external optical connector. The optical connector can be removably attached to the receptacle, via a ‘separable’ or ‘demountable’ or ‘detachable’ action that accurately optically aligns the optical fibers to the optical ports communicating optical signals with optoelectronic device along a desired optical path. To maintain optical alignment for each connect and disconnect and reconnect, this connector needs to be precisely and accurately aligned passively to the receptacle. In accordance with the present invention, the connector and receptacle are aligned with one another using a passive mechanical alignment, specifically, elastic averaging alignment, constructed from geometric features on two facing contact surfaces/bodies. With the foregoing as introduction, the present invention may be summarized below.

One aspect of the present invention is directed to a high-density optical connector for demountable coupling to an external connection point associated with an external component (i.e., operationally positioned in relation to the external component, positioned in relation to or directly on the external component). The high-density optical connector comprises a fiber array block having a body supporting a 2-D array of optical fibers in a bundle (i.e., a fiber array) and a corresponding 2-D array of microlenses (glass, silicon, or polymer) aligned with the optical fibers for shaping (e.g., collimating/diverging) light from/to the I/O ends of the optical fibers. The I/O ends of the optical fibers are in a plane, which may come into contact with facing surfaces of the array of microlenses. The fiber block includes a coupling surface (which may be an integral surface of the fiber block or a separate substrate defining the surface), which has a planar array of passive alignment demountable coupling features matching a complementary array of coupling features on a receptacle associated with the external connection point. The coupling surface defines an optical region (e.g., an opening or a region of transparent material, such as glass, silicon, or polymer) aligned with the microlens array and fiber array, permitting passage of light to and from optical fibers. The demountable coupling features are distributed adjacent to the optical region in reference to the microlens array and fiber array.

In one embodiment, the demountable coupling features are symmetrically distributed about at least one of two orthogonal median or symmetry axes of the optical region of the coupling surface. In one embodiment, the 2-D array of elastic averaging features are uniformly distributed on a defined area of the coupling surface, with coverage of the array of elastic averaging features on such defined area interrupted by the optical region, which may be an opening, a window, or a microlens array. In one embodiment, the optical region is located nearer to one side of the coupling surface from which the symmetry axis of the optical region extends, and the demountable coupling features are symmetrically distributed about the same symmetry axis. In another embodiment, the optical region is a central region of the coupling surface, with the demountable coupling features distributed about and around all sides of the central region. In a further embodiment, the demountable coupling features are symmetrically distributed about both orthogonal symmetry axes of the optical region.

In one embodiment, the demountable coupling features are configured as a planar 2-D array of elastic averaging features defined on the coupling surface, with complementary matching array of elastic averaging features defined on facing surface of the receptacle. In one embodiment, the array of coupling features comprises at least two rows of elastic averaging features along each side of the central region of the coupling surface.

In one embodiment, the coupling surface is integral to the body of the fiber block (i.e., the coupling surface is a surface of the fiber block), with the microlens array provided in the central region of the coupling surface. In a further embodiment, the microlens array is integrally defined at the coupling surface of the body of the fiber block, with optical fibers aligned to corresponding microlenses.

In another embodiment, the coupling surface is defined on a cover plate having a substrate separate from the body of the fiber block, with the microlens array aligned to the central region of the coupling surface. In a further embodiment, the microlens array is integrally defined on the body of the fiber block, with optical fibers aligned to corresponding microlenses, and the cover plate is attached to the body of the fiber block. In another embodiment, the microlens array is defined in a substrate separate from and attached to the body of the fiber block, aligned to the central region of the coupling surface of the cover plate, and the cover plate is attached to substrate of the microlens array.

Wherein the substrate of the microlens array is integral to the substrate of the cover plate, wherein the cover plate substrate comprises the central portion defined with the 2D array of microlenses, and the demountable coupling features defined around the central region.

In one embodiment, the external connection point comprises a receptacle having a substrate defined with complementary elastic averaging features and an optical region aligned with the optical region of the coupling surface for passage of light between the optical fibers and the I/O ports associated with the external component upon demountable coupling of the coupling surface to the receptacle. The receptacle has complementary/matching demountable coupling features distributed adjacent to the optical region of the receptacle. In an alternate embodiment, the receptacle may further include a microlens array at the optical region of the receptacle, mirroring the coupling surface and microlens array of the optical connector.

In one embodiment, a reflective member, e.g., a micro prism or a prism array, turns light to/from optical fibers along an optical path that deviates from the longitudinal optical axis of the optical fibers to optically coupled with the I/O ports associated with the external component, wherein the micro prism comprises a block having a slanted surface for internal reflection, a vertical surface facing the optical fiber array, and a horizontal surface facing the external component.

In one embodiment, the fiber block supports the optical fibers with their longitudinal optical axis substantially orthogonal to the coupling surface and the plane of the receptacle extends substantially vertically, facing the coupling surface. The micro prism is positioned between the receptacle and external component, turning light between the optical region of the receptacle and the I/O ports associated with the external component. The vertical surface of the prism faces a back surface of the receptacle without the elastic averaging features, at the optical region of the receptacle, and the horizontal surface of the prism faces the I/O ports associated with the external component, whereby the internally reflective slant surface of the prism directs light between the optical fibers and the I/O ports associated with the external component, via the optical regions of the coupling surface and the receptacle.

In one embodiment, the prism is integral to the back surface of the receptacle. In a further embodiment, the microlens array is defined on the prism (at its vertical surface and/or horizontal surface), alternative or in addition to the microlens array defined on the fiber block.

In an alternate embodiment, the fiber block supports the optical fibers with longitudinal optical axis substantially parallel to the coupling surface, and the plane of the receptacle extends substantially parallel to the plane of the external component. The prism is positioned between the coupling surface and the fiber block, directing light between the optical fibers and the optical region of the coupling surface to optically coupled with the external component. The vertical surface of the prism faces the fiber array (and/or microlens array if provided) of the fiber block to direct/receive light to/from the optical fibers, and the horizontal surface of the prism faces the rear of the coupling surface of the cover plate (without the elastic averaging features), at the optical region of the coupling surface, whereby the internally reflective slant surface of the prism directs light between the optical fibers and the I/O ports associated with the external component, via the optical regions of the coupling surface and the receptacle.

In one embodiment, the prism is integral to the rear of the coupling surface of the cover plate, and/or the microlens array of the fiber block. In a further embodiment, the microlens array is defined on the prism (at its vertical surface and/or horizontal surface), alternative or in addition to the microlens array defined on the fiber block. In a specific embodiment, the 2-D array of microlenses are defined on a prism block aligned with optical fibers.

In one embodiment, the internally reflective slant surface turns the optical path by substantially 90 degrees to the longitudinal optical axis of the optical fibers.

In one embodiment, the receptacle is an integral part of external component. In another embodiment, the receptacle is a separate part of external component.

In one embodiment, the external component is a photonic integrated circuit (PIC) chip with a 2-D array of I/O ports matching the I/O of the 2-D array of optical fibers. In an alternate embodiment, the external component is another high-density optical connector similar to the high-density optical connector.

Another aspect of the present invention is directed to a passive alignment demountable coupling between a high-density optical connector and an optoelectronic device in an optically aligned position, comprising the afore described high-density optical connector and receptacle positioned in relation to the optoelectronic device.

A further aspect of the present invention is directed to a method of forming a high-density optical fiber connector, comprising wafer processing of substrates to form cover plates, specifically the coupling surfaces on substrates of cover plates to define elastic averaging features thereon, and further a method of forming receptacles for high-density optical connector, specifically the coupling surfaces on substrates of receptacles to define elastic averaging features thereon.

With the foregoing summary as introduction, the present invention may be further described in further details below to support the features recited in the claims.

### BRIEF DESCRIPTION OF THE DRAWINGS

For a fuller understanding of the nature and advantages of the invention, as well as the

preferred mode of use, reference should be made to the following detailed description read in conjunction with the accompanying drawings. In the following drawings, like reference numerals designate like or similar parts throughout the drawings.

FIG. 1A illustrates a high-density optical connector to be demountably coupled to a receptacle on an external component, in accordance with one embodiment of the present invention; FIG. 1B illustrates the coupling features defined on the coupling surface of the fiber block of the high-density optical connector, in accordance with one embodiment of the present invention; FIG. 1C is an exploded view of the high-density optical connector shown in FIG. 1A.

FIG. 2A schematically illustrates complementary planar arrays of elastic averaging features, which could be implemented at opposing mating/coupling surfaces, the coupling surface of the fiber block and the coupling surface of the receptacle, in accordance with one embodiment of the present invention; FIGS. 2B and 2C illustrate perspective and side views of demountable coupling between the coupling surfaces. FIG. 2D schematically illustrates the contact points between complementary arrays of elastic averaging features, in accordance with one embodiment of the present invention; FIG. 2E is a schematic perspective view illustrating contacts between complementary bumps in the complementary arrays of elastic averaging features, in accordance with one embodiment of the present invention.

FIG. 3A schematically illustrates a portion of a fiber block having an array of through cylindrical channels for supporting optical fibers, in accordance with one embodiment of the present invention; FIG. 3B schematically illustrates a portion of a fiber array and a portion of a microlens array of the optical connector through which light to/from the optical fibers passes through.

FIG. 4A illustrates a high-density optical connector to be demountably coupled to a receptacle on an external component, in which a prism is deployed to turn light to/from the fiber array with optical axis parallel to the coupling surface of the cover plate, in accordance with another embodiment of the present invention; FIG. 4B is an exploded view of the high-density optical connector shown in FIG. 4A.

FIGS. 5A and 5B illustrate mounting/demounting a high-density optical connector to a receptacle that has a plane extending vertically from an external component, and a prism is deployed to turn light through the receptacle, in accordance with another embodiment of the present invention.

FIGS. 6A to 6G illustrate the assembly of a further embodiment of a high-density optical connector in accordance with another embodiment of the present invention, and demountable coupling thereof to a receptacle in accordance with another embodiment of the present invention.

FIGS. 7A to 7C illustrate the assembly of a further embodiment of a high-density optical connector, and demountable coupling thereof to an external component in the form of another high-density optical connector in accordance with another embodiment of the present invention.

FIGS. 8A to 8D illustrate the assembly of yet another embodiment of a high-density optical connector, and demountable coupling thereof to an external component in the form of another high-density optical connector in accordance with a further embodiment of the present invention.

FIGS. 9A to 9E illustrate demountable coupling of a similar embodiment of a high-density optical connector to another embodiment of a receptacle having a microlens array in accordance with another embodiment of the present invention.

FIGS. 10A to 10F illustrate demountable coupling of a high-density optical connector including a prism to turn light to/from a further embodiment of a fiber array with optical axis parallel to the coupling surface of the fiber block, in accordance with another embodiment of the present invention.

FIGS. 11A to 11D illustrate demountable coupling of a high-density optical connector including a prism to turn light to/from another embodiment of a fiber array with optical axis parallel to the coupling surface of the fiber block, in accordance with another embodiment of the present invention.

FIGS. 12A to 12F illustrate demountable coupling of a high-density optical connector including another embodiment of a prism to turn light to/from a stacked fiber array with optical axis parallel to the coupling surface of the fiber block, in accordance with another embodiment of the present invention.

FIGS. 13A to 13D illustrate another embodiment of a high-density optical connector having a staggered, stacked fiber array.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

One aspect of the present invention is directed to a optical fiber connector for demountable coupling to an external connection point associated with an external component. The connection point is operationally positioned in relation to the external component (e.g., an optoelectronic device, such as a PIC), which may be positioned in relation to (e.g., on a circuit board supporting the PIC) or directly on the external component.

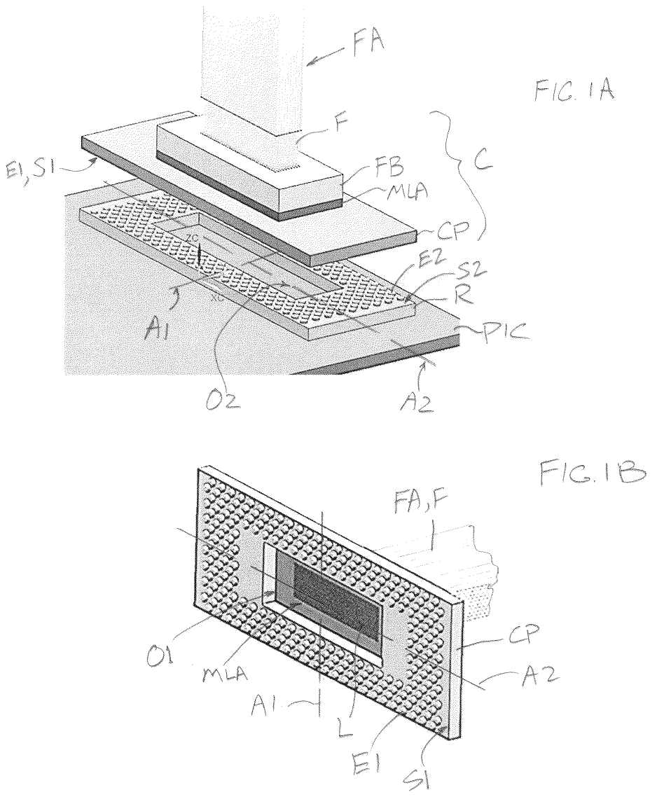

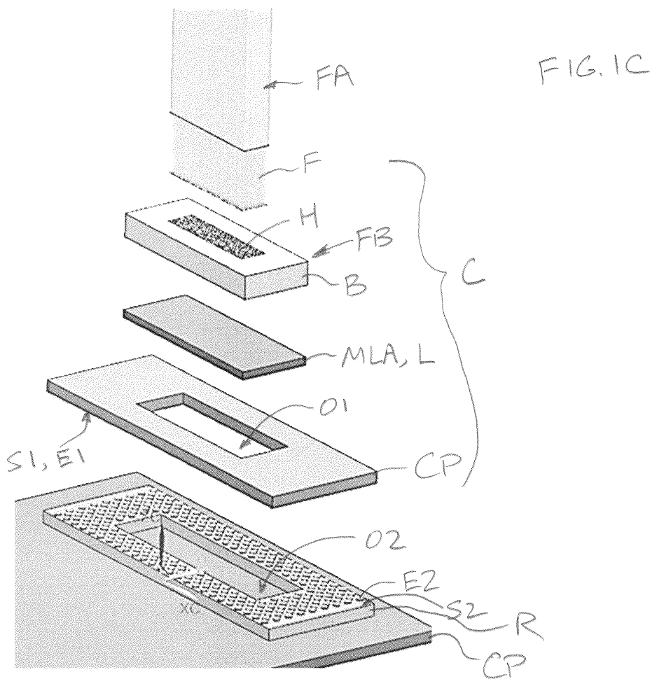

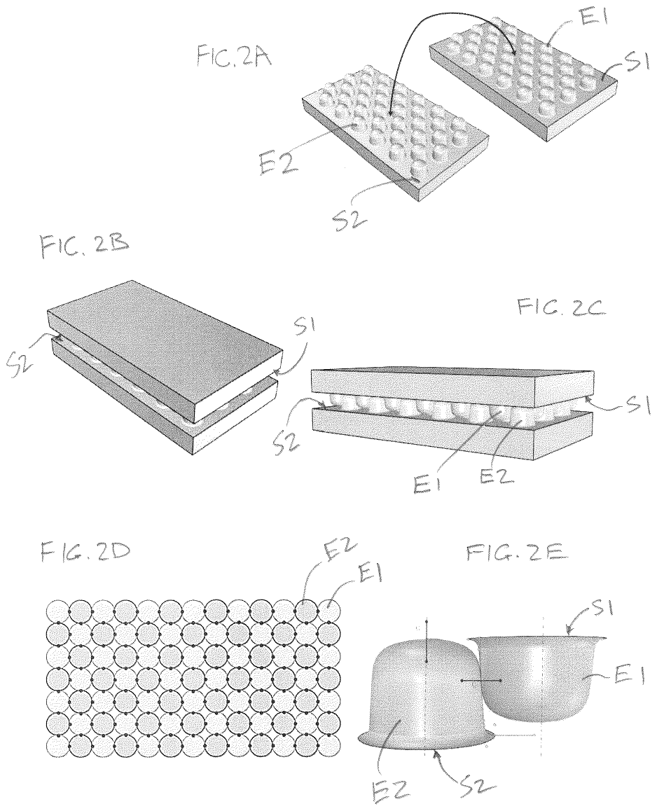

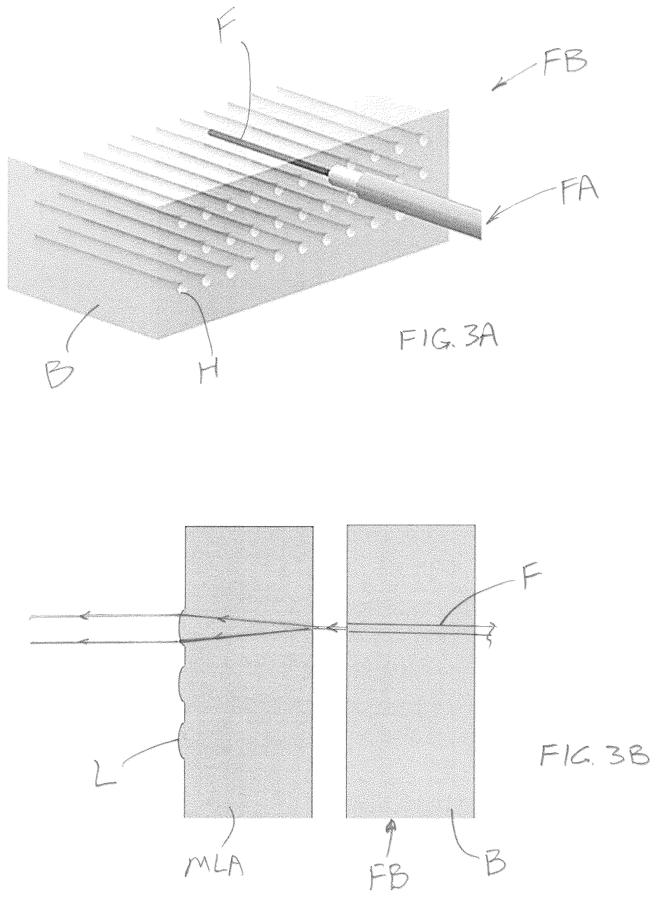

The high-density optical connector of the present invention comprises FIGS. 1A-1C illustrate demountable coupling a high-density optical connector C to a receptacle on an external component, in accordance with one embodiment of the present invention. In FIG. 1A, the high-density optical connector C (hereinafter also simply referred to as “optical connector”) which comprises a fiber block FB having a body B supporting a 2-D array of optical fibers F in a bundle (i.e., a M×N fiber array FA). FIG. 3A schematically illustrates a portion of a fiber block FB having an array of holes H for supporting the bare end sections of the optical fibers F (i.e., with cladding exposed, without protective buffer and jacket layers of the fiber bundle) in the holes H. The body B may be made of glass, polymer, or metal. The body B may be made of several separate layers, having complementary grooves (e.g., C-grooves, V-grooves, etc.) on facing surfaces of the layers to define the holes H when the layers are assembled by stacking to form the body B. The ends of the optical fibers F in the fiber array FA may be placed between opposing grooves as the layers are assembled.

A corresponding 2-D microlens array MLA having a planar array of microlenses L (which may be made of glass, silicon, or polymer) are aligned with the optical fibers for shaping light to/from the optical fibers F. For example, the microlenses L are configured to collimate incident light from and diverge incident light to the I/O ends of the optical fibers F. FIG. 3B schematically illustrates a portion of the body of the fiber block FB supporting the fiber array FA and a portion of a microlens array MLA of the optical connector C through which light to/from the optical fibers F passes through. The microlens array MLA and the body B of the fiber block FB supporting the fiber array FA are pre-assembled together, e.g., bonded permanently. The microlens array MLA serve to expand (e.g., collimate) the beams of light output from the optical fibers F to reduce the effect of optical misalignment. The microlens array MLA includes lens L to reshape collimated light and focus on the end face of an optical fiber F. Conversely, the lens L can also expand the beam from an optical fiber F, e.g., from a 9 um SMF and collimate it to a larger beam, say 50-100 um. The fiber array FA may have a 12×12 array and array of other number of optical fibers F. The fiber count may be from 48 up to 1500.

FIG. 3B shows an air gap between the fiber block FB and microlens array MLA. The air gap may be filled with an epoxy that has a specific value of the optical index of refraction, for the following two cases: (a) where the epoxy's refractive index equals that of the core of the fiber F, or (b) where the epoxy's refractive index equals that of the microlens array MLA.

The microlens array MLA may be implemented in a substrate as schematically shown, which are available from various suppliers in the field. The I/O ends of the optical fibers F are in a plane, exposed through the holes H of the body B of the fiber block FB. The I/O ends of the optical fibers F may come into contact with facing surface of the microlenses L.

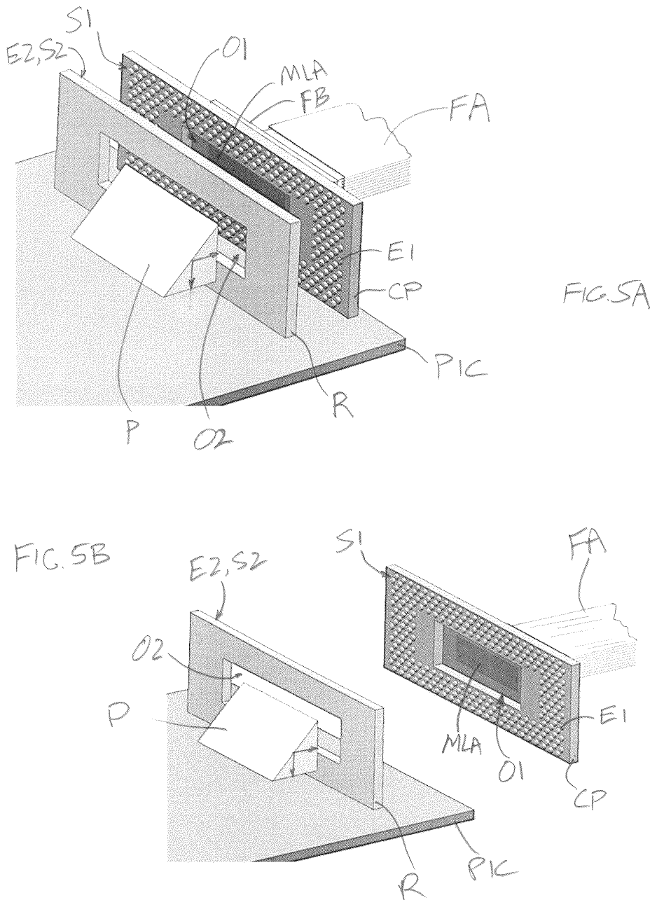

The fiber block FB (in this embodiment, the fiber block FB has a separate cover plate CP) is provided with a coupling surface S1, which has a planar 2-D array of passive alignment demountable coupling features E1 matching a complementary planar 2-D array of coupling features E2 on a receptacle R associated with the external connection point (e.g., at the top of a PIC as illustrated in the example shown in FIG. 1A). As illustrated in the embodiment of FIG. 1B, the optical connector C further includes a cover plate CP that defines the coupling surface S1. In this embodiment, the cover plate CP has a substrate separate from the body B of the fiber block FB. The array of coupling features E1 is defined on the coupling surface S1 of the cover plate CP. The coupling surface S1 defines an optical region O1 aligned with the microlens array MLA and fiber array FA, permitting passage of light to and from the optical fibers F. The optical region O1 may be an opening or a region of material that is optically transparent, such as glass, silicon or polymer. For a cover plate CP having the coupling surface S1, the substrate of cover plate CP may be or may include a light transparent material at the optical region O1. The demountable coupling features are distributed adjacent to the optical region in reference to the microlens array MLA and fiber array FA. The cover plate CP and/or R may be made of metal or silicon, or if light transparency is desired in some embodiments having an integrated microlens array (discussed below in connection with FIGS. 6-9), made of glass or silicon that is optically transparent to the working wavelength of the intended optical signals between the optical fibers F and the external component/optoelectronic device PIC. Silicon is transparent to light in common infrared (IR) band for optical communications (e.g., 1310 nm-1550 nm). The elastic averaging features E1 and E2 may comprise complementary array of bumps manufactured (e.g., by etching, machining, etc.) into facing surfaces of the cover plate CP and the receptacle R.

FIG. 2A schematically illustrates an embodiment of complementary planar arrays of coupling features in the form of elastic averaging features E1 and E2, which could be respectively implemented at opposing coupling surfaces S1 of cover plate CP and S2 of receptacle R. FIGS. 2B and 2C illustrate perspective and side views of demountable coupling between coupling surfaces S1 and S2. FIG. 2D schematically illustrates the contact points between complementary arrays of elastic averaging features E1 and E2. FIG. 2E is a schematic perspective view illustrating contacts between complementary features E1 and E2 in the shape of bumps in the complementary arrays of elastic averaging features.

The arrays of elastic averaging features E1 and E2 are complementary to each other, with opposing interstitial two-dimensional planar arrays of discrete protrusions (or bumps) defining opposing arrays of interstices. The discrete protrusions are separated and isolated from one another on the respective coupling surfaces S1 and S2. When the cover plate CP is pressed against the receptacle R with the first and second arrays of elastic averaging features E1 and E2 mating towards each other, the opposing arrays of protrusions intermesh, with the protrusions defined on the cover plate CP received in corresponding interstices defined on the receptacle R, wherein protrusion surfaces of each adjacent pair of protrusions are in point contact (as shown in FIG. 2D, with the exception of the protrusions at or near the edges, each protrusion makes four point contacts with adjacent four opposing protrusions). The contact points are elastic and create a network of parallel springs that create forces to achieve passive alignment. The array of elastic averaging features E1 mated to the array of elastic averaging features E2 correspond to an elastic averaging coupling that demountably couples the cover plate CP to the receptacle by passive alignment, which coupling provides for repeated decoupling and recoupling with endurable repeatability to maintain alignment accuracy. Further reference is made to US Patent Publications Nos. US20240085633A1 and US20240142722A1 for detail discussions of these elastic averaging features. Elastic averaging features having other geometries may be adopted for coupling surfaces S1 and S2 to achieve the desired demountable coupling based on elastic averaging.

In the embodiment illustrated in FIGS. 1A and 1B, the demountable coupling features E1 and E2 are symmetrically distributed about at least one of two orthogonal median or symmetry axes A1 and A2 of the respective optical regions O1 and O1 in the coupling surfaces S1 and S2. In this embodiment, optical region O1 is a central region of coupling surface S1 and similarly the optical region O2 is a central region of coupling surface S2. Each of the optical regions O1 and O2 are symmetrically arranged about both orthogonal symmetry axes A1 and A2 of the respective coupling surfaces S1 and S2. The demountable coupling features E1 and E2 are also symmetrically distributed about the central optical region and hence about both orthogonal symmetry axes A1 and A2. Accordingly, in this embodiment, the demountable coupling features E1 and E2 are also symmetrically distributed about two orthogonal median or symmetry axes A1 and A2 of the respective coupling surfaces S1 and S2.

As illustrated by the embodiment of FIG. 1, the respective 2-D array of elastic averaging features E1 and E2 are uniformly distributed on a defined area of the corresponding coupling surface S1 and S2, with coverage of the respective array of elastic averaging features E1 and E2 on such defined area interrupted by the corresponding optical regions O1 and O2, which in this case is an opening or window. In other case, to be further discussed below, the optical regions O1 and O1 may comprise a microlens array. The uniform distribution and coverage of elastic averaging features on coupling surfaces also apply to the embodiments discussed below.

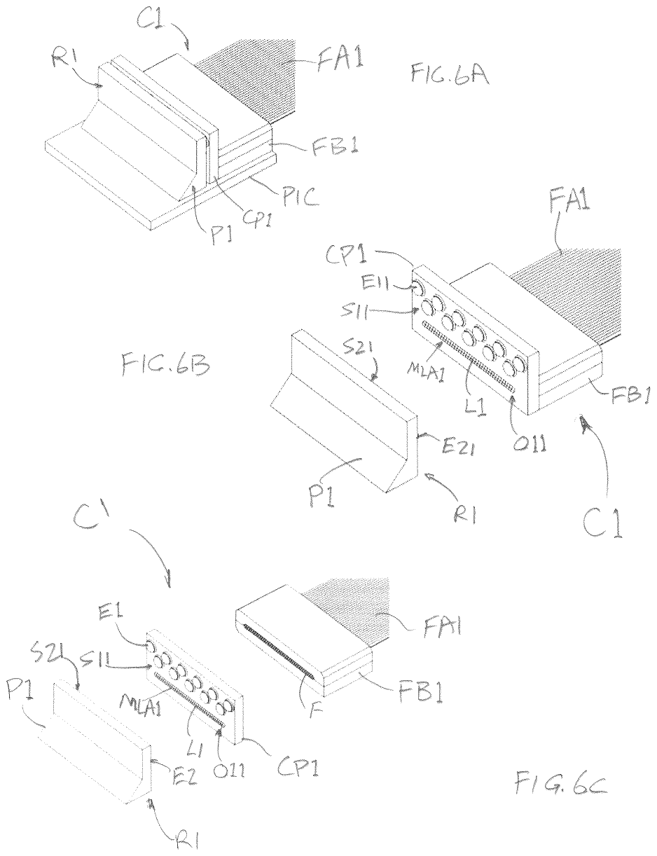

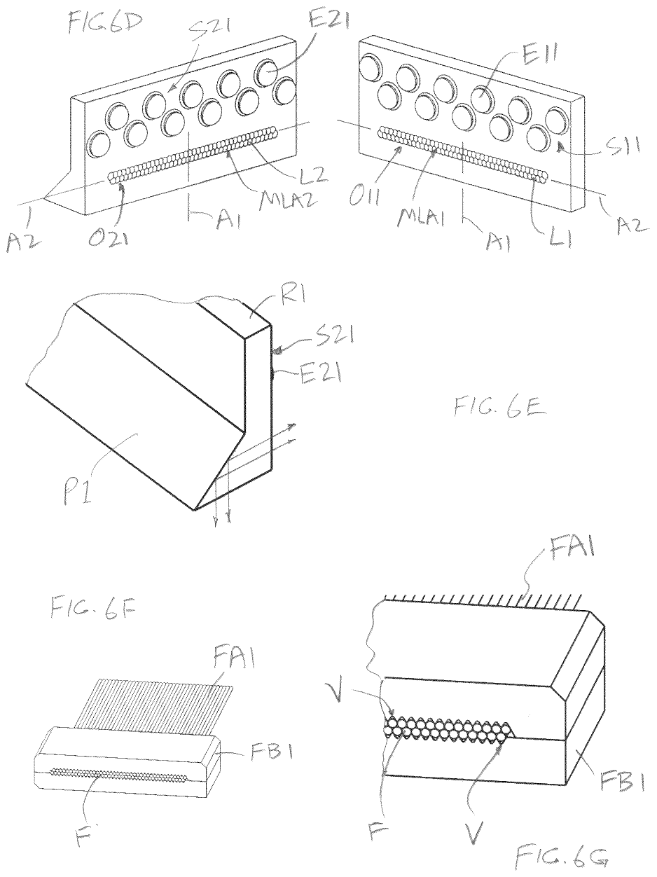

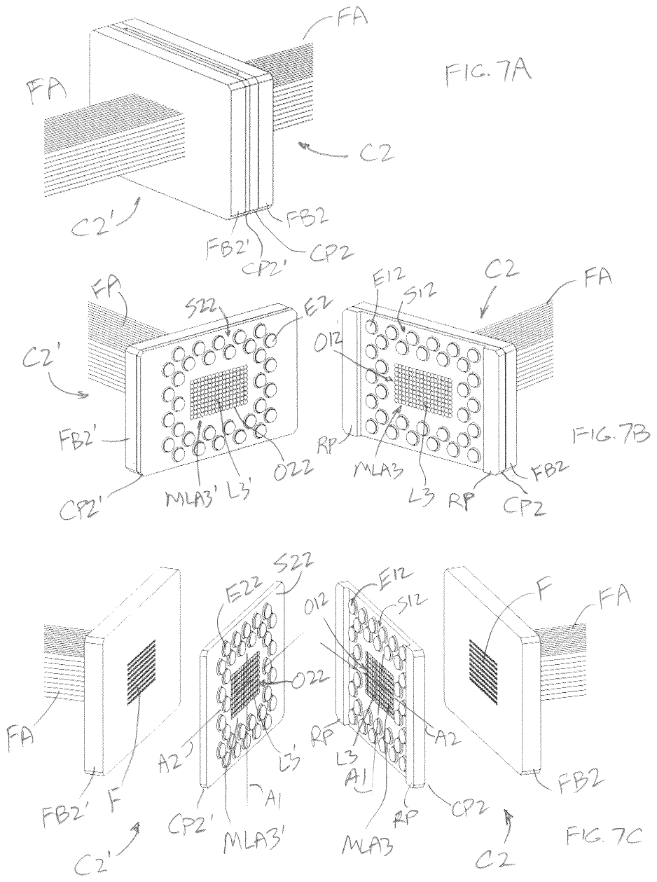

In this embodiment, the demountable coupling features E1 and E2 are distributed about and around all sides of the respective central optical regions O1 and O2. The array of coupling features respectively comprises at least two rows of corresponding elastic averaging features E1 and E2 at and extending along each side of the corresponding central optical regions O1 and O2 of the coupling surface S1 and S2. In the exemplary embodiment shown in FIGS. 1A and 1B, there are at least four rows of elastic averaging features E1 and E2 at and extending along each long side of the optical regions O1 and O2 parallel to axis A2, and at least seven rows of elastic averaging features E1 and E2 at and extending along each short side of the optical regions O1 and O2 parallel to axis A1. The number of rows may differ for other embodiments (see, e.g., FIGS. 7, 8 and 9).

With the optical connector C demountably coupled to the receptacle R, the coupling surface S1 of the cover plate CP mates with the coupling surface S2 of the receptacle R, with the optical regions O1 and O2 of the cover plate CP and the receptacle in alignment to pass light therebetween.

In some embodiments (e.g., FIGS. 6, 10, 11 and 12 discussed later below), the optical region is located nearer to one side of the coupling surface from which a symmetry axis of the optical region extends, and the demountable coupling features are symmetrically distributed about this symmetry axis.

As illustrated in the embodiment of FIG. 1C, the fiber block FB, the microlens array MLA and the cover plate CP are attached in a stack to form the optical connector C. In this embodiment, the microlens array MLA is defined in a substrate separate from and attached to the body B of the fiber block FB, with the fiber array FA optically aligned to the central optical region O1 of the coupling surface S1 of the cover plate CP, and the cover plate CP is attached to the substrate of the microlens array MLA with the optical region O1 optically aligned to the microlens array MLA. Instead of defining the coupling surface S1 on a separate cover plate CP and/or a separate microlens array MLA, the coupling surface S1 and/or microlens array MLA may be an integral surface of the body B of the fiber block FB and the cover plate is attached to the body of the fiber block (not shown).

FIG. 1 illustrates the demountable coupling of the optical connector C with the optical axis of fiber array FA substantially orthogonal to the mated coupling surfaces S1 and S2 of the cover plate CP and receptacle R, and orthogonal to the external component PIC. In another embodiment, a reflective member, e.g., a micro prism or a prism array, turns light to/from optical fibers along an optical path that deviates from the longitudinal optical axis of the optical fibers to optically coupled with the I/O ports associated with the external component, wherein the micro prism comprises a block having a slanted surface for internal reflection, a vertical surface facing the optical fiber array, and a horizontal surface facing the external component.

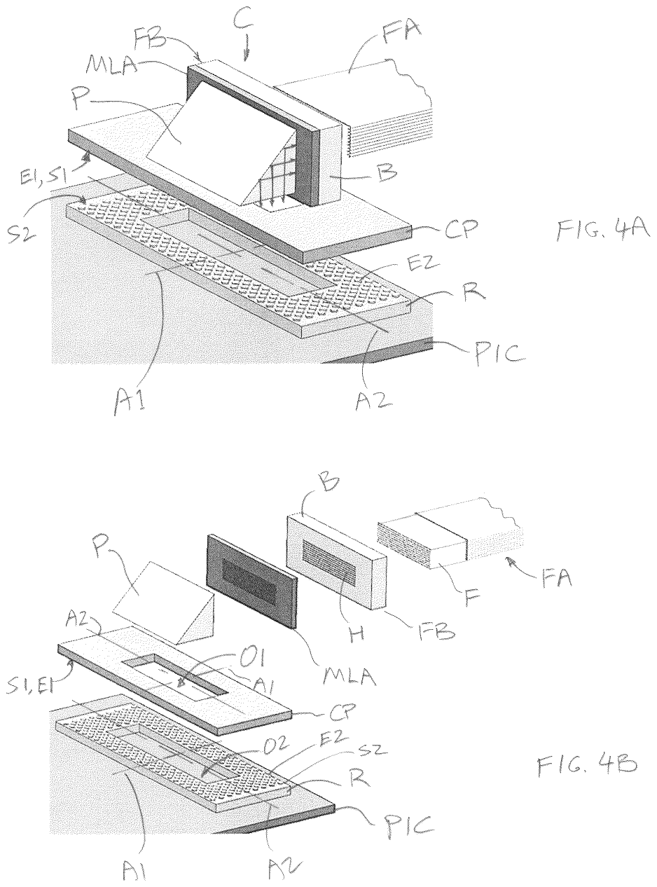

FIG. 4A illustrates demountable coupling of the high-density optical connector C discussed above to the receptacle R on a PIC, with the optical axis of the fiber array FA substantially parallel to the mated coupling surfaces S1 and S2 of the cover plate CP and receptacle R. FIG. 4B is an exploded view of the high-density optical connector shown in FIG. 4A, which is similar to that in the earlier embodiment of FIGS. 1A and 1C. The receptacle R and cover plate CP in this embodiment are similar to those in the earlier embodiment. The difference between this embodiment and the earlier embodiment is the addition of a prism P deployed to turn light to/from the optical fibers F having optical axis parallel to the coupling surface S1, the receptacle and the external component PIC. The prism P is attached between the microlens array MLA and the cover plate CP, in optical alignment to the microlens array MLA and the optical region O1 of the coupling surface S1/cover plate CP. The vertical surface of the prism faces with an optical path aligned to the microlens array MLA. The horizontal surface of the prism P faces with an optical path aligned to the optical region O1 of the coupling surface S1 of the cover plate CP. The prism P bends or turns light transmitted between the optical fibers F and the external component PIC, through the optical regions O1 and O2 of the receptacle R and the cover plate CP and the microlens array MLA. In this embodiment, the prism P turns light by substantially 90 degrees by internal reflection at its slant surface. Variation of similar optical configuration including a prism will be discussed later below further in connection with the embodiments of FIGS. 6, 10, 11 and 12.

As a variation of this embodiment (and similarly applicable to the other embodiments described below, e.g., FIGS. 5, 6, 9, 10, 11 and 12), instead of the fibers F being substantially parallel to the coupling surfaces, the high density optical connector C may be demountable coupled to the receptacle R on a PIC, with the optical axis of the fiber array FA supported by the body B of the connector C at an acute angle to the mated coupling surfaces S1 and S2 of the cover plate CP and receptacle R (variation not shown in the drawings).

FIGS. 5A and 5B illustrate another embodiment of demountable coupling of the high-density optical connector C discussed above to the receptacle R. The optical connector C, receptacle R and cover plate CP in this embodiment are similar to those in the earlier embodiment of FIGS. 1 and 4. The difference between this embodiment and the earlier embodiment of FIG. 4 is in the support of the receptacle R by the prism P to extend the plane of the receptacle R substantially vertically from the external component PIC. The prism P turns light between the optical region O2 of the receptacle R and the external component PIC. In this embodiment, the fiber block FB supports the optical fibers F with their longitudinal optical axis substantially orthogonal to the coupling surfaces S1 and S2 of the cover plate CP and the receptacle R, with the plane of coupling surface S2 of the receptacle R extends substantially vertically, facing the coupling surface S1 of the cover plate CP. The prism P is positioned between the receptacle R and external component PIC, turning light between the optical region O2 of the receptacle and the I/O ports associated with the external component PIC. The vertical surface of the prism P faces a back surface of the receptacle R (opposite the coupling surface S2, without elastic averaging features), with an optical path aligned to the optical region O2 of the receptacle R. The horizontal surface of the prism P faces with an optical path optically aligned to the I/O ports associated with the external component PIC, whereby the internally reflective slant surface of the prism P directs light between the optical fibers F and the I/O ports associated with the external component PIC, via the optical regions O1 and O2 of the coupling surfaces S1 and S2 of the cover plate CP and the receptacle R.

FIGS. 6A to 6G illustrate the assembly of a further embodiment of a high-density optical connector C1, and demountable coupling thereof to another embodiment of a receptacle R1. Similar to the previous embodiment of FIG. 5, the receptacle R1 is supported to extend the plane of the receptacle R1 substantially vertically from the external component PIC. The coupling surface S21 of the receptacle R1 extends vertically as in the embodiment of FIG. 5. Compared to the embodiment of FIG. 5, the receptacle R1 includes an integral prism P1 in this embodiment. Otherwise, the optical path between the optical connector and the I/O ports with external component PIC are quite similar, namely, taking a substantially 90 degree turn by total internal reflection at the slant side of the prism P1. The prism P1 can be coated with a metal on the slant surface.

The high-density optical connector C2 includes a fiber block FB1 in the form of two opposing ferrule halves supporting two staggered, stacked rows of optical fibers F of a 2×40 fiber array FA1 (better shown in FIGS. 6F and 6G). The two rows of optical fibers F are stacked with the two rows of optical fibers F in contact. Each row of fibers F is supported and aligned by a set of V-grooves V on the corresponding opposing ferrule halves.

The opposing coupling surface S11 and S21 of the cover plate CP1 and R1 have a different configuration of matching complementary arrays of coupling features E11 and E21 compared to the previous embodiments. In this embodiment, the respective optical regions O11 and O21 of the opposing coupling surfaces S11 and S21 of the cover plate CP1 and R1 are located nearer to one side of the respective coupling surfaces. The symmetry axis A1 of the respective optical regions O11 and O21 extends orthogonal to the longitudinal optical regions. The matching complementary arrays of demountable coupling features E11 and E21 are symmetrically distributed about this symmetry axis A1. Compared to the previous embodiments, while the arrays of coupling features E11 and E21 may have a different overall array configuration, the individual feature may have a similar structure schematically and generally shown in FIG. 2 to implement demountable coupling of the opposing coupling surfaces S11 and S21 based on elastic averaging. In particular, the coupling features may be in the shape of bumps that come into contact when the coupling surfaces S11 and S21 are mated, in the manner illustrated in FIG. 2. In this embodiment, there are two rows of elastic averaging features E11 and E22, respectively, each row symmetrically distributed about symmetry axis A1 of the corresponding optical regions O11 and O21. The two rows of elastic averaging features E11 and E22 are distributed on only one side of the median/symmetry axis of the corresponding optical regions O11 and O21.

The optical region O11 of the coupling surface S11 of the cover plate CP1 in the optical connector C1 in this embodiment are defined with an integrated microlens array MLA1. As more clearly shown in FIG. 6D, the microlens array MLA1 includes two staggered, stacked rows of microlenses in a 2×40 array, with optical axis aligned to that of the optical fibers F in the 2×40 fiber array FA1.

The optical region O21 of the coupling surface S21 of the receptacle R1 is defined with an integrated microlens array MLA2. As more clearly shown in FIG. 6D, the microlens array MLA2 includes two staggered, stacked rows of microlenses in a 2×40 array, with optical axis of the microlenses L2 aligned to that of the microlenses L1 in the 2×40 microlens array MLA1 when the coupling surfaces S11 and S12 are mated when the cover plate CP1 is demountably coupled to the receptacle R1. As in the previous embodiment of FIG. 5, the slanted side of the integral prism P1 is aligned with the I/O ports on the external component PIC. Accordingly, the slanted side turns by total internal reflection light between the fiber array FA1 and the I/O ports of the external component PIC.

In an alternate embodiment, microlens array is provided in either the cover plate CP1 or the receptacle R1, but not both. In which case, the corresponding optical region O11 or O21 without the microlens array would be replaced with an array of through-holes (e.g., 2×40 array of through-holes), a wide opening, or a transparent window conforming to the 2×40 array of the optical fibers F.

As in the previous embodiments, the cover plate CP1 and or receptacle R1 may be made of glass or silicon that is optically transparent to the working wavelength of the intended optical signals between the optical fibers F and the I/O ports of the external component/optoelectronic device PIC. The elastic averaging features E1 and E2 may comprise complementary array of bumps etched into facing surfaces of the cover plate CP1 and the receptacle R1.

In the embodiments illustrated and discussed above, the external component PIC is a photonic integrated circuit (PIC) chip with a 2-D array of I/O ports matching the I/O of the 2-D array of optical fibers. In an alternate embodiment, the external component is another high-density optical connector similar to the high-density optical connector to be demountably coupled thereto. FIGS. 7A to 7C illustrate the assembly of a further embodiment of a high-density optical connector C2, and demountable coupling thereof to an external component in the form of another high-density optical connector C2′ in accordance with another embodiment of the present invention.

In the embodiment of FIG. 7, the optical connector C2 is similar to optical connector C in the embodiment of FIGS. 1, 4 and 5 discussed above, with the exception of the integral microlens array MLA3 at the cover plate CP2 and the coupling features E12 at the coupling surface S12 of the cover plate CP2. The fiber array FA may have a similar or different M×N array of optical fibers F as the previous embodiment of fiber array, which does not deviate from the present invention. As illustrated, the fiber array FA has a 9×16 array of 144 optical fibers F supported by a fiber block FB2.

A cover plate CP2 is attached to a fiber block FB2. Similar to the previous embodiment of FIGS. 1, 4 and 5, the coupling surface S12 of the cover plate CP2 extends substantially orthogonal to the optical axis of the optical fibers F. In this embodiment, instead of a separate substrate of microlens array, the substrate of the microlens array MLA3 is integral to the substrate of the cover plate CP2, wherein the cover plate substrate comprises the central portion defined with the 2D microlens array MLA3, and the demountable coupling features defined around the central optical region O12, with microlenses L3 optically aligned to the optical fibers F of the fiber array FA.

The complementary optical connector C2′ has generally similar structural components and features as the optical connection C2, with a cover plate CP2′ on a fiber block FB2′. The cover plate CP2′ corresponds to a receptacle similar to the function of the receptacles discussed in the previous embodiments. The fiber block FB2′ supports the fiber array FA of 9×16 array of 144 optical fibers F. The cover plate CP2′ is attached to a fiber block FB2′. The coupling surface S22 of the cover plate CP2′ extends substantially orthogonal to the optical axis of the optical fibers F. Instead of a separate substrate of microlens array, the microlens array MLA3′ is integral to the substrate of the cover plate CP2′, at a central optical region O22, with microlenses L3′ optically aligned to the optical fibers F of the fiber array FA.

As in the previous embodiments, while the arrays of coupling features E12 and E22 may have a different overall array configuration, the individual feature may have a similar structure schematically and generally shown in FIG. 2 to implement demountable coupling of the opposing coupling surfaces S12 and S22 based on elastic averaging. In particular, the coupling features may be in the shape of bumps that come into contact when the coupling surfaces S12 and S22 are mated, in the manner illustrated in FIG. 2. In this embodiment, the respective optical regions O12 and O22 of the opposing coupling surfaces S12 and S22 of the cover plate CP2 and CP2′ are located at the center of the respective coupling surfaces. The opposing coupling surface S12 and S22 of the cover plate CP2 and CP2′ have a different configuration of matching complementary arrays of coupling features E12 and E22 compared to the previous embodiments. The demountable coupling features E12 and E22 are distributed about and around all sides of the respective central optical regions O12 and O22. In this embodiment, the array of coupling features respectively comprises two rows of corresponding elastic averaging features E12 and E22 at and extending along each side of the corresponding central optical regions O12 and O22 of the coupling surface S12 and S22. The elastic averaging features E12 and E22 at and extending along each long side of the optical regions O12 and O22 are parallel to symmetry axis A2, and the elastic averaging features E12 and E22 at and extending along each short side of the optical regions O12 and O22 are parallel to symmetry axis A1. The matching complementary arrays of demountable coupling features E12 and E22 are symmetrically distributed about symmetry axis A1 and symmetry axis A2.

When the optical connector C2 is demountably coupled to the optical connector C2′ with the cover plate CP2 demountably coupled to the cover plate CP2′ as shown in FIG. 7A, the coupling surfaces S12 and S22 are mated and the optical axis of the microlenses L3 in microlens array MLA3 are aligned to the axis of the microlenses L3′ in microlens array MLA3′.

As in the previous embodiments, the cover plate CP2 and/or cover plate CP2′ may be made of glass, silicon, or a polymer that is optically transparent to the working wavelength of the intended optical signals between the optical fibers F of the optical connectors C2 and C2′. The elastic averaging features E12 and E22 may comprise complementary array of bumps manufactured into facing surfaces of the cover plates CP2 and CP2′.

As shown in FIGS. 7B and 7C, a raised pad RP is provided along each short edges of the cover plate CP2. The raised pads RP provide some level of barrier to debris from contaminating the opposing coupling surfaces S12 and S22. The height of the raised pads RP above the coupling surface S12 is chosen to not contact the opposing contact surface S22 when the coupling surfaces S12 and S22 are mated, to avoid over-constraining in the direction normal to the coupling surfaces S12 and S22, which would otherwise not conform to elastic averaging coupling. For example, the height of the raised pads RP can be the same height or less than the height of the elastic averaging features/bumps E12, which is shorter than the opposing elastic averaging features/bumps E22 (see corresponding matting bumps E1 and E2 schematically illustrated in FIG. 2E). The elastic averaging features E12 on the coupling surface S12 of the cover plate S12 do not touch the opposing coupling surface S22 when the cover plate CP2 is fully mated to the cover plate CP2′ (which in this case, the receptacle of the external component). For this elastic averaging coupling, constraints are established by a plurality of point contacts between the complementary arrays of elastic averaging features E12 and E22, conforming to the schematic illustration in FIG. 2D.

In an alternate embodiment, the coupling surface is integral to the body of the fiber block (i.e., the coupling surface is a surface of the fiber block) with the microlens array provided in the central optical region of the coupling surface, without a separate cover plate as in the preceding embodiment. In a further embodiment, the microlens array is integrally defined with the coupling surface of the body of the fiber block, with optical fibers aligned to corresponding microlenses.

FIGS. 8A to 8D illustrate a modified assembly of a high-density optical connector C3, and demountable coupling thereof to an external component in the form of another high-density optical connector C3′. Compared to the embodiment of FIG. 7, in this embodiment, the cover plate is essentially integrated to the respective fiber blocks FB3 and FB3′ of the optical connector C3 and opposing optical connector C3′. Otherwise, the configurations and features of the optical connectors C3 and C3′ are similar to the corresponding optical connectors C2 and C2′ in the preceding embodiment of FIG. 7.

FIGS. 8C and 8D are sectional views to further illustrate demountable coupling of the unitary structures that define the fiber blocks FB3 and FB3′, the coupling surfaces S12 and S22, and the elastic averaging features E12 and E22. As illustrated, the fibers F is inserted into blind holes in the fiber block FB3/FB3′, in optical alignment with a corresponding microlens L3/L3′ at the central optical regions O12/O22 in the corresponding coupling surface S12/S22.

With the optical connector C3 demountably coupled to the optical connector C3′ with the coupling surfaces S12 and S22 mated as shown in FIG. 8C, the optical axis of the microlenses L3 in microlens array MLA3 are aligned to the axis of the microlenses L3′ in microlens array MLA3′.

The fiber block FB3/FB3′ may be made of glass or silicon that is optically transparent to the working wavelength of the intended optical signals between the optical fibers F of the optical connectors C3 and C3′. The elastic averaging features E12 and E22 may comprise complementary array of bumps etched into facing coupling surfaces S12 and S22.

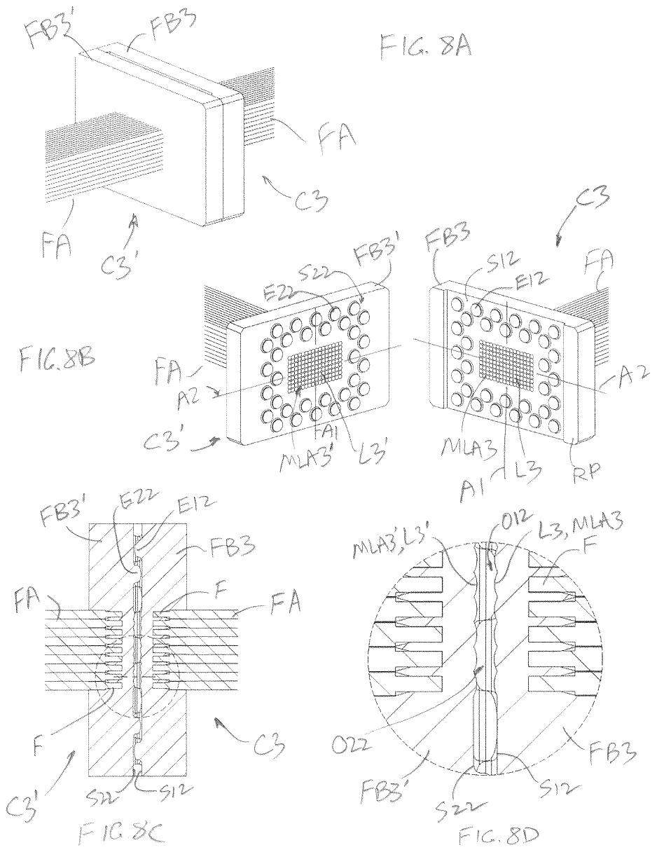

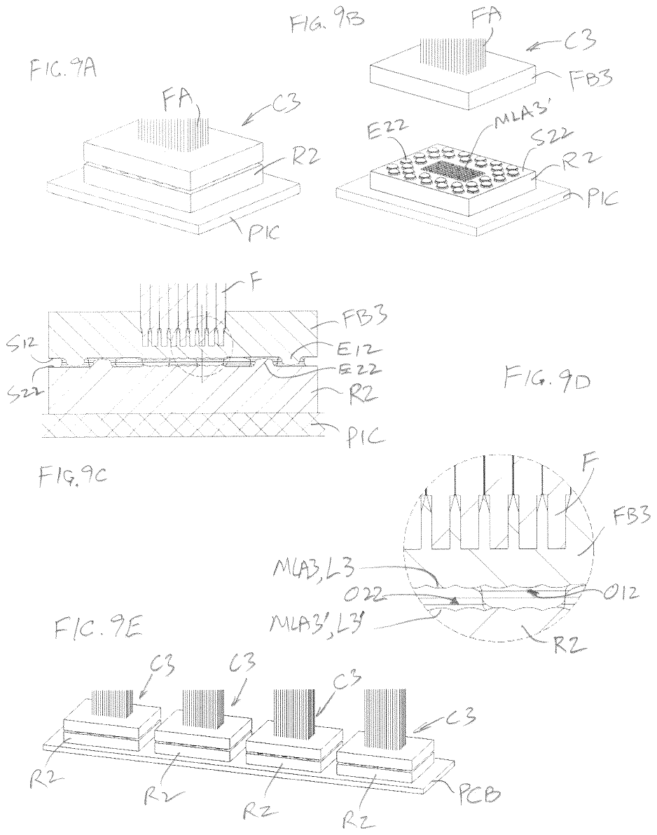

FIGS. 9A to 9E illustrate demountable coupling of the high-density optical connector C3 in the preceding embodiment to a receptacle having a matching complementary coupling surface including a microlens array similar to the optical connector C3′. References are made to FIGS. 8B to 8D for the details of optical connector C3. For simplicity, the raised pads RP are omitted in the drawings.

The receptacle R2 has a coupling surface S22 similar to the coupling surface S22 of the optical connector C3′ in the previous embodiment of FIG. 8. In this embodiment, there is no provision for optical fibers F in the body of the receptacle R2. As in the preceding embodiment, the coupling surface S22 defines a central optical region O22 defined with an integral microlens array MLA3′ mirroring the coupling surface and microlens array MLA3 of the optical connector C3. The receptacle R2 has complementary/matching demountable coupling features E22 distributed adjacent to the optical region O22. As in the previous embodiment of FIG. 1, the receptacle R2 is attached to the top to a support surface with I/O ports in relation to an external component PIC (e.g., an optoelectronic device such as a photonic integrated circuit). In this embodiment, the microlenses L3′ is optically aligned to the I/O ports of the external component PIC.

With the optical connector C3 demountably coupled to the receptacle R2 with the coupling surfaces S12 and S22 mated as shown in the sectional view of FIGS. 9C and 9D, the optical axis of the microlenses L3 in microlens array MLA3 are aligned to the axis of the microlenses L3′ in microlens array MLA3′. In this embodiment, the fiber array FA is supported with the optical axis of the optical fibers F substantially orthogonal to the coupling surface of the receptacle R2.

The receptacle R2 may be made of glass or silicon that is optically transparent to the working wavelength of the intended optical signals between the optical fibers F of the optical connector C3 and external component PIC. The elastic averaging features E2 and E22 may comprise complementary array of bumps etched into facing coupling surfaces S12 and S22.

FIG. 9E is a schematic illustration of multiple demountable couplings of high-density optical connectors C3 and receptacles R2. The receptacles R2 could be mounted onto PICs as shown in FIG. 9A to 9C or to a printed circuit board PCBs as in FIG. 9E.

FIGS. 10 to 12 illustrate specific embodiments of high-density optical connectors alternate to the embodiment of FIG. 4 described above, directed to demountable coupling of high-density optical connectors including a prism to turn light to/from a fiber array with optical axis parallel to the coupling surface of the receptacle. In all these embodiments, the respective fiber block supports the optical fibers with longitudinal optical axis substantially parallel to the demountable coupling surface of the receptacle, and the plane of the coupling surface of the receptacle extends substantially parallel to the plane of the external component.

The embodiment of FIG. 10 is comparable to the embodiment of FIG. 4, with similar configuration of optical path. FIG. 10A illustrates a specific example of a 4×20 fiber array FA of 80 fiber channels of a high-density optical connector C, with the exemplary array dimensions of 250 μm pitch between adjacent optical fibers, and 250 μm centerline spacing between rows of optical fibers. As in FIG. 4, the prism (or microprism array) P is positioned between the coupling surface S13 defined by the cover plate CP3 and the microlens array MLA, directing light between the optical fibers F and the optical region O13 of the coupling surface of the cover plate CP3 to optically coupled with the external component PIC. Referring to the section view in FIG. 10D, the vertical surface of the prism P is attached to the microlens array MLA of the fiber block FB that supports the array of optical fiber F in through holes. The horizontal surface of the prism P faces the rear of the coupling surface S13 of the cover plate CP3 (the surface without the elastic averaging features E13), at the optical region O13 of the coupling surface S13. The internally reflective slant surface of the prism P directs light between the optical fibers F and the I/O ports associated with the external component PIC, via the optical regions O13 and O23 of the coupling surfaces S13 and S23 of the cover plate CP3 and the receptacle R3.

While FIG. 10 illustrates the prism P, microlens array MLA and fiber block FB as separate components, two of more of these components can be integrated into a unitary structure. In one embodiment, the microlens array MLA (e.g., four rows of lenses having similar pitch and inter-row distance) is integrally defined on the front of the fiber block FB in optical alignment with the optical fiber F supported thereby for beam shaping. In another embodiment, the prism P is integral to the microlens array MLA for beam shaping. The microlens array MLA may be defined on the prism P at its vertical surface for beam shaping. Alternatively, the microlens array MLA may be defined on its horizontal surface for beam shaping. In a further embodiment, a 2-D microlens array MLA is defined on both the vertical surface and the horizontal surface for beam shaping. The prism P, microlens array MLA and fiber block FB may all be integrated into a unitary structure.

In one embodiment, the receptacle R3 may be an integral part of external component PIC.

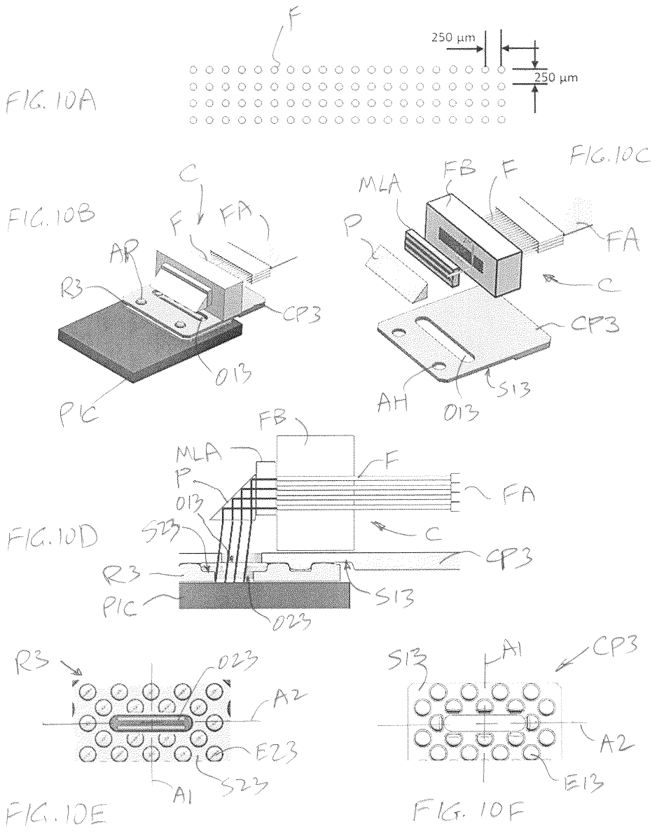

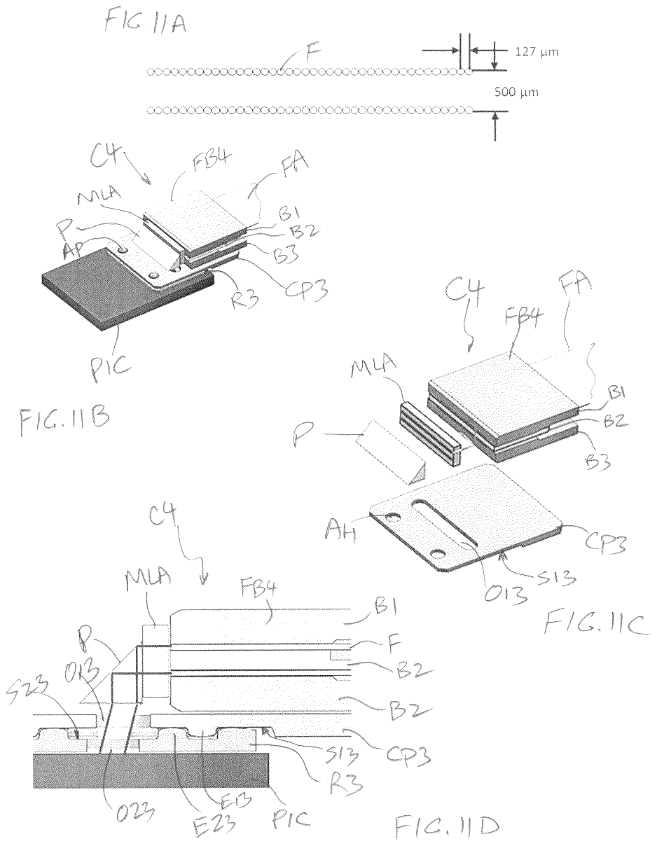

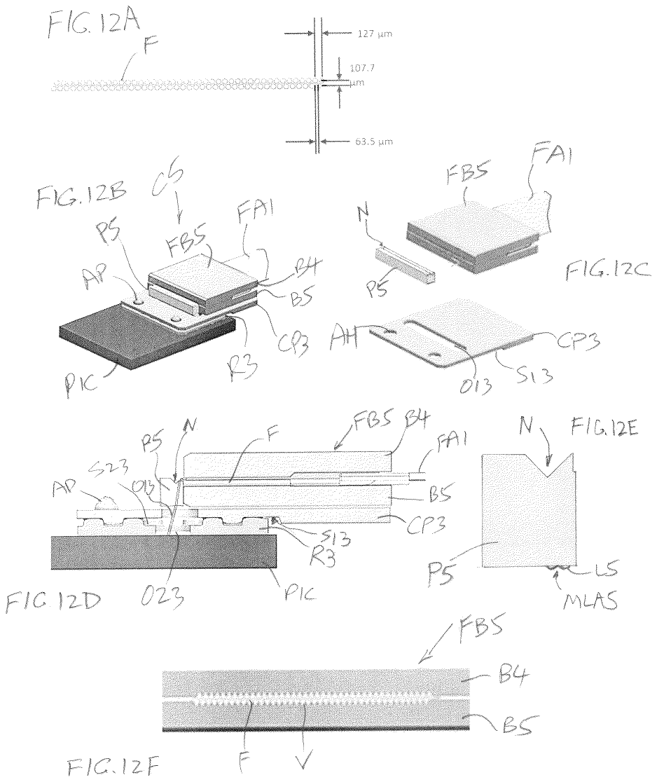

FIGS. 10E and 10F schematically illustrate the configurations of the coupling surfaces of the cover plate CP3 and the receptacle R3, which are also applicable to the embodiments in FIGS. 11 and 12. In FIG. 10E, the elastic averaging features E23 are distributed around the optical region O23 of the receptacle R3. In FIG. 10F, the elastic averaging features E13 are distributed around the optical region O13 of the cover plate CP3. As described in connection with earlier embodiments, the elastic averaging features E13 and E23 form an elastic averaging coupling when the coupling surfaces S13 and S23 are mated when the cover plate CP3 is demountably coupled to the receptacle R3. As in the previous embodiments, the opposing coupling surface S13 and S23 of the cover plate CP3 and R3 have a different configuration of matching complementary arrays of coupling features E13 and E23. The demountable coupling features E13 and E23 are distributed about and around all sides of the optical regions O13 and O23. In this embodiment, the array of coupling features respectively comprises at least two rows of corresponding elastic averaging features E13 and E23 at and extending along each side of the corresponding central optical regions O13 and O23 of the coupling surface S13 and S23. The elastic averaging features E13 and E23 at and extending along each long side of the optical regions O13 and O23 are parallel to symmetry axis A2, and the elastic averaging features E13 and E23 at and extending along each short side of the optical regions O13 and O23 are parallel to symmetry axis A1. The matching complementary arrays of demountable coupling features E12 and E22 are symmetrically distributed about symmetry axis A1 and symmetry axis A2. As described in connection with earlier embodiments, the elastic averaging features E13 and E23 form an elastic averaging coupling when the coupling surfaces S13 and S23 are mated upon demountable coupling of the cover plate CP3 to the receptacle R3.

To facilitate initial placement of the cover plate CP3 onto the receptacle R3, complementary passive pre-alignment holes AH and pins AP are provided on the cover plate CP3 and receptacle R3. Pre-alignment is a rough alignment to locate the cover plate CP3 onto the receptacle R3 with the matching complementary elastic averaging features E13 and E23 positioned interstitially prior to preloading to mate the cover plate CP3 to the receptacle R3. Other fiducials may be used, such as matching complementary notches and protrusions along the edges of the cover plate CP3 and receptacle R3. This rough alignment is relatively loose, and is not part of the demountable coupling based on elastic averaging between the cover plate CP3 and the receptacle R3.

FIG. 11 is a variation of the embodiment of FIG. 10, with similar configuration of optical path. FIGS. 11A-11D illustrate a specific example of a 2×40 fiber array FA of 80 fiber channels a high-density optical connector C4, with the exemplary array dimensions of 127 μm pitch between adjacent optical fibers, and 500 μm centerline spacing between rows of optical fibers). The microlens array MLA in this embodiment has an array of lenses (e.g., two rows of lenses having similar pitch and inter-row distance) for matching the array of optical fibers F in the fiber block FB4 for beam shaping.

In this embodiment, given the optical fibers F are spaced at a pitch close to the diameter of the optical fibers F, the fiber block FB4 comprises a stacked body structure, including three separate ferrule layers B1, B2 and B3, each having complementary grooves (e.g., C-grooves, V-grooves, etc.) on facing surfaces of adjacent layers to define channels/holes for securely holding the optical fibers. The layers B1, B2 and B3 are assembled in a stack to form the body of the fiber block FB4. The ends of the optical fibers F in the fiber array FA are placed between the grooves as the layers B1, B2 and B3 are stacked. Instead of having opposing grooves to hold each optical fiber F, the optical fibers F may be held in place by opposing grooved surface and flat surface. For example, the middle layer B2 may have flat, groove-less surfaces opposing the layers B1 and B3. Alternatively, the middle layer B2 has grooved surfaces opposing flat, groove-less surfaces of layers B1 and B3.

Other than the structures and components mentioned above, this embodiment is similar to the preceding embodiment (e.g., with similar prism P, receptacle R3 and cover plate CP3). Comparing sectional view of FIG. 11D to FIG. 10D, the optical path between the optical fibers F and the I/O ports on the external component PIC is similar. As discussed in connection with the preceding embodiment, the alternate embodiments of the prism, microlenses, receptacle, cover plate, etc., are applicable to this embodiment as well. As described in connection with earlier embodiments, the elastic averaging features E13 and E23 form an elastic averaging coupling when the coupling surfaces S13 and S23 are mated upon demountable coupling of the cover plate CP3 to the receptacle R3.

FIG. 12 is a variation of the embodiment of FIG. 11, with similar configuration of optical path. FIGS. 12A-12F illustrate a specific example of a 2×40 fiber array FA of 80 fiber channels of a high-density optical connector C5, with the exemplary array dimensions of 127 μm pitch between adjacent optical fibers, and 107.7 μm centerline spacing between rows of optical fibers). This embodiment incorporates a fiber block FB 5 that is similar to the fiber block FB1 disclosed above in connection with the embodiment of FIG. 6, namely, the optical fibers F are supported in a staggered, stacked configuration, sandwiched between two grooved surfaces with opposing V-grooves V of the ferrule halves B4 and B5 (see, FIG. 12F, which is a variation of the fiber block FB1 in FIGS. 6F and 6G).

The prism P5 adopted in this embodiment a block having a generally rectangular sectional geometry, and a V-shaped notch N at the top surface defining a slant surface of the prism P5 for total internal reflection of the beam path. As illustrated in the sectional views in FIGS. 12D and 12E, the prism P5 has a vertical surface attached to the front of the fiber block FB5, with the slant surface of the notch N in optical alignment with the optical fibers F in the fiber block FB5. As in the previous embodiments of FIGS. 10 and 11, the bottom horizontal surface of the prism P5 faces the rear of the coupling surface S13 of the cover plate CP3 (the surface without the elastic averaging features E13), at the optical region O13 of the coupling surface S13. The internally reflective slant surface of notch N of the prism P5 directs light between the optical fibers F and the I/O ports associated with the external component PIC, via the optical regions O13 and O23 of the coupling surfaces S13 and S23 of the cover plate CP3 and the receptacle R3.

In this embodiment, the microlens array MLA5 is integral to the bottom of the prism P5, having an array of lens (e.g., 2 staggered rows of lenses L5) matching the array of optical fibers F in the fiber block FB5 for beam shaping. Alternative, or in addition, to the microlens array MLA5, a microlens array may be provided between the prism P5 and the fiber block FB5 (e.g., integral to the vertical surface of the prism P5,1 or in a separate substrate, or integral to the end face of the fiber block FB5.

Other than the structures and components mentioned above, this embodiment is similar to the preceding embodiment (e.g., with similar receptacle R3 and cover plate CP3). Comparing FIG. 12D to FIG. 11D, the optical path between the optical fibers F and the I/O ports on the external component PIC is similar. As discussed in connection with the preceding embodiment, the alternate embodiments of the prism, microlenses, receptacle, cover plate, etc., are applicable to this embodiment as well. As described in connection with earlier embodiments, the elastic averaging features E13 and E23 form an elastic averaging coupling when the coupling surfaces S13 and S23 are mated upon demountable coupling of the cover plate CP3 to the receptacle R3.

In the above described embodiments, the demountable passive alignment couplings between the high-density optical connectors and the external components are defined without use of any complementary alignment pin and alignment hole (other than rough pre-alignment to facilitate elastic averaging alignment. While the disclosed embodiments adopted a specific elastic averaging coupling involving specific elastic averaging features, it is understood that the inventive optical connector module can implement other types of elastic averaging features without departing from the scope and spirit of the present invention. For example, US Patent Publication No. 2016/0161686A1 and U.S. Pat. No. 11,500,166B2 disclose elastic averaging features suitable for connection of an optical connector to a support receptacle. Furthermore, the high-density optical connector and external component/receptacle may be demountably coupled and passively aligned with one another using a passive mechanical alignment other than elastic averaging, such as kinematic or quasi-kinematic alignment, constructed from various geometric features on the two bodies. The present invention is not limited to any specific demountable coupling based on passive alignment.

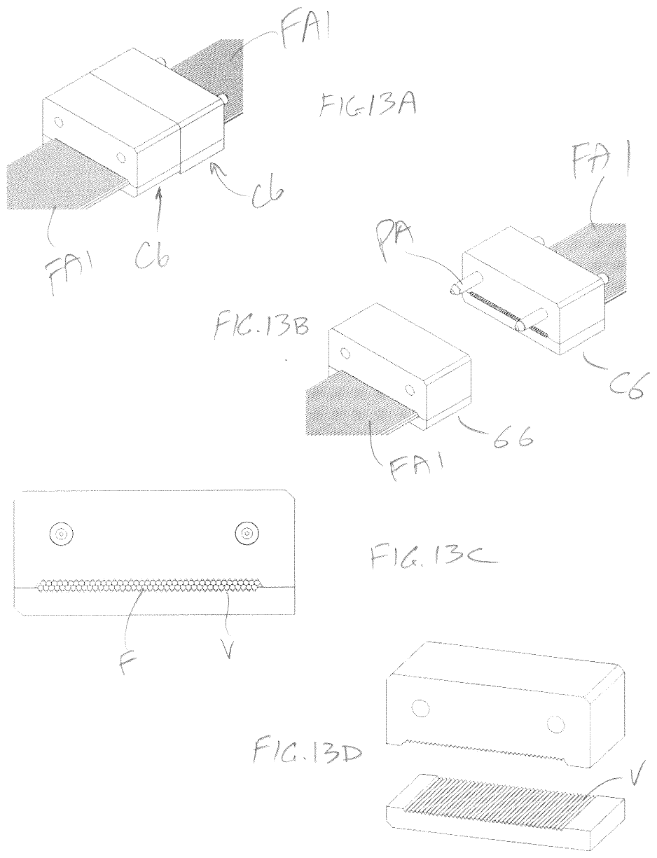

For example, FIGS. 13A to 13D illustrate another embodiment of a high-density optical connector C6 having a staggered, stacked fiber array, which could be interconnected to another similar high-density optical connector C6 using alignment pins PA. As in the embodiment in FIGS. 6F and 6G, the optical fibers F are sandwiched between two ferrule halves having V-grooves V.

Another aspect of the present invention is directed to a passive alignment demountable coupling between a high-density optical connector and an optoelectronic device in an optically aligned position, comprising the afore-described high-density optical connector and receptacle positioned in relation to the optoelectronic device. A further aspect of the present invention is directed to a method of forming a high-density optical fiber connector, comprising wafer processing of substrates to form cover plates, specifically the coupling surfaces on substrates of cover plates to define elastic averaging features thereon, and further a method of forming receptacles for high-density optical connector, specifically the coupling surfaces on substrates of receptacles to define elastic averaging features thereon. References are made to US20250284077A1 for further details of wafer processing of substrates for cover plates and receptacles.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

1. A high-density optical connector for demountable coupling to an external connection point associated with an external component (operationally positioned in relation to the external component, positioned at a distance to or on the external component), comprising:
a fiber block comprising:
a body supporting a 2-D array of optical fibers;
a 2-D array of microlenses aligned with the optical fibers for beam shaping (e.g., collimating/diverging) light to and from the optical fibers,
a coupling surface having passive alignment demountable coupling features matching complementary coupling features on a receptacle associated with the external connection point to be coupled,
wherein the coupling surface comprises an optical region aligned with the microlens array and the optical fiber array permitting passage of light to and from optical fibers, with the demountable coupling features distributed adjacent the optical region in reference to the microlens array and optical fiber.

2. A high-density optical connector as in claim 1, wherein the demountable coupling features comprises a 2-D array of elastic averaging features uniformly distributed on a defined area of the coupling surface, with coverage of the array of elastic averaging features on such defined area interrupted by the optical region, which may be an opening, a window, or a microlens array.
